(19) United States
(12) Patent Application Publication
(10) Pub. No.: US 2006/0201329 A1
(43) Pub. Date: Sep. 14, 2006

(54) Coffee pod making method and apparatus

(76) Inventor: David H. Lynch, Olathe, KS (US)

Correspondence Address: HOVEY WILLIAMS LLP, 2405 GRAND BLVD., SUITE 400, KANSAS CITY, MO, 64108, US

(21) Appl. No.: 11/079,372

(22) Filed: Mar. 14, 2005

(51) Int. Cl. A23L 1/00

(52) U.S. Cl. 99/275

(57) ABSTRACT

An apparatus for assembling a coffee pod includes a filter sheet, a receptacle, and a plunger. A portion of the plunger conforms to a portion of a cavity of the receptacle so that when the filter sheet is placed over the receptacle cavity and the plunger is thrust against the filter sheet and into the cavity, the plunger forces a portion of the sheet to conform to the cavity. The plunger is removed, leaving the sheet in the cavity. Coffee grounds are placed in the portion of the sheet that conforms to the cavity, and the sheet is folded to envelop the ingredient.

### TECHNICAL FIELD

The present invention relates to a method and apparatus for making coffee. More particularly, it relates to a method and apparatus for hand-assembling a coffee pod so that a user may fill the pod with a user-selected amount and type of coffee grounds.

### BACKGROUND AND SUMMARY

Coffee makers are well known in the art. Typically, coffee makers include a filter for holding coffee grounds, wherein a user places the filter into the coffee maker and pours a desired amount and type of coffee grounds into the filter. The coffee maker transfers heated water into the filter such that the water mixes with the grounds, receives a flavor therefrom, and then passes through the filter into a coffee pot. This open filter system has the advantage of enabling a user to determine a flavor of coffee by choosing a particular type of coffee grounds to place in the filter, and to determine a strength of the coffee by controlling the amount of coffee grounds and/or water that are used to make the pot of coffee.

Such traditional coffee makers are not well adapted to making a single serving of coffee. They are designed to accommodate quantities of water and coffee grounds commensurate with a pot of coffee, for example, and therefore may be unnecessarily inefficient and slow when used to make a single serving of coffee. In response to this limitation, single serving coffee makers have been developed that employ coffee “pods,” or packets of coffee grounds commensurate in size for a single serving of coffee. Unfortunately, use of such coffee makers—often referred to as “pod brewers”—suffers from problems and limitations. Coffee pods, for example, are sealed packages of coffee grounds that prevent a user from altering the type or amount of coffee grounds contained therein. Therefore, the user is constrained to making coffee according to a flavor and strength of the coffee pod. This is particularly disadvantageous where, for example, a user prefers to make coffee from freshly-ground beans or prefers a type or mixture of coffee grounds not available in a coffee pod. Furthermore, because the coffee pods are small, forcing a pod membrane open to change the amount or type of coffee grounds contained therein can result in the coffee grounds washing or falling out of the pod during a brewing cycle and ending up in a cup of coffee.

The present invention provides an apparatus and method for enabling a user to assemble a coffee pod with a particular amount and type of coffee grounds. The apparatus provides a filter sheet, a receptacle, a plunger, and a measuring container. The plunger mates with a cavity of the receptacle so that when the filter sheet is placed over the receptacle cavity and the plunger is thrust against the filter sheet and into the cavity, the plunger forces a portion of the sheet to conform to the cavity. When the plunger is removed, the filter sheet remains in the cavity. Coffee grounds are placed in the portion of the sheet that conforms to the cavity, and the sheet is folded to envelop the ingredient, forming a hand-assembled coffee pod. The coffee pod is placed in a pod brewer and used in the same manner as a traditional coffee pod.

### BRIEF DESCRIPTION OF THE DRAWINGS

FIG. 1 is a perspective view of a coffee maker for use with a coffee pod, wherein the coffee pod is assembled using a method and apparatus of the present invention, and wherein a lid of the coffee maker is in an open position;

FIG. 2 is a perspective view of the coffee maker of FIG. 1, wherein the lid is in a closed position;

FIG. 3 is a perspective view of an apparatus for assembling a coffee pod constructed in accordance with the principles of a first embodiment of the invention;

FIG. 4 is a sectional side elevation view of a base and a receptacle of the apparatus of FIG. 3, illustrating the receptacle resting in a recess of the base, wherein a notch in a rim of the recess receives a handle of the receptacle;

FIG. 5 is a perspective view of the base, the receptacle, a filter sheet, and a plunger of the apparatus of FIG. 3, wherein the plunger is placed in the receptacle to force a portion of the filter sheet to conform to a cavity of the receptacle;

FIG. 6 is a perspective view of the base, receptacle, and filter sheet of FIG. 5, wherein the plunger has been removed and coffee grounds have been placed in the portion of the filter sheet conforming to the cavity of the receptacle;

FIG. 7 is a perspective view of the base, receptacle and filter sheet of FIG. 6, illustrating a first fold in the filter sheet to envelop the coffee grounds;

FIG. 8 is a perspective view of the base, receptacle, and filter sheet of FIG. 7, illustrating a second fold in the filter sheet to further envelop the coffee grounds;

FIG. 9 is a perspective view of the base, receptacle, and filter sheet of the apparatus of FIG. 8, illustrating a third fold in the filter sheet to further envelop the coffee grounds;

FIG. 10 is a perspective view of the base, receptacle, and filter sheet of the apparatus of FIG. 9, illustrating a fourth fold in the filter sheet to further envelop the coffee grounds and complete formation of the coffee pod;

FIG. 11 is a perspective view of an apparatus for assembling a coffee pod constructed in accordance with the principles of a second embodiment of the invention;

FIG. 12 is a sectional side elevation view of a base and a receptacle of the apparatus of FIG. 11, illustrating the receptacle resting in a recess of the base, wherein an outer surface of the base supports a handle of the receptacle;

FIG. 13 is a perspective view of the base, the receptacle, a filter sheet, and a plunger of the apparatus of FIG. 11, wherein the plunger is placed in the receptacle to force a portion of the filter sheet to conform to a cavity of the receptacle;

FIG. 14 is a perspective view of the base, receptacle, and filter sheet of FIG. 13, wherein the plunger has been removed and coffee grounds have been placed in the portion of the filter sheet conforming to the cavity of the receptacle;

FIG. 15 is a perspective view of the base, receptacle, and filter sheet of FIG. 14, illustrating a first fold in the filter sheet to envelop the coffee grounds;

FIG. 16 is a perspective view of the base, receptacle, and filter sheet of FIG. 15, illustrating a second fold in the filter sheet to further envelop the coffee grounds; and

FIG. 17 is a perspective view of the base, receptacle, and filter sheet of FIG. 16, illustrating a third fold in the filter sheet to further envelop the coffee grounds and complete formation of the coffee pod.

### DETAILED DESCRIPTION

The present invention is susceptible of embodiment in many different forms. While the drawings illustrate and the specification describes certain preferred embodiments of the invention, it is to be understood that such disclosure is by way of example only. There is no intent to limit the principles of the present invention to the particular disclosed embodiments.

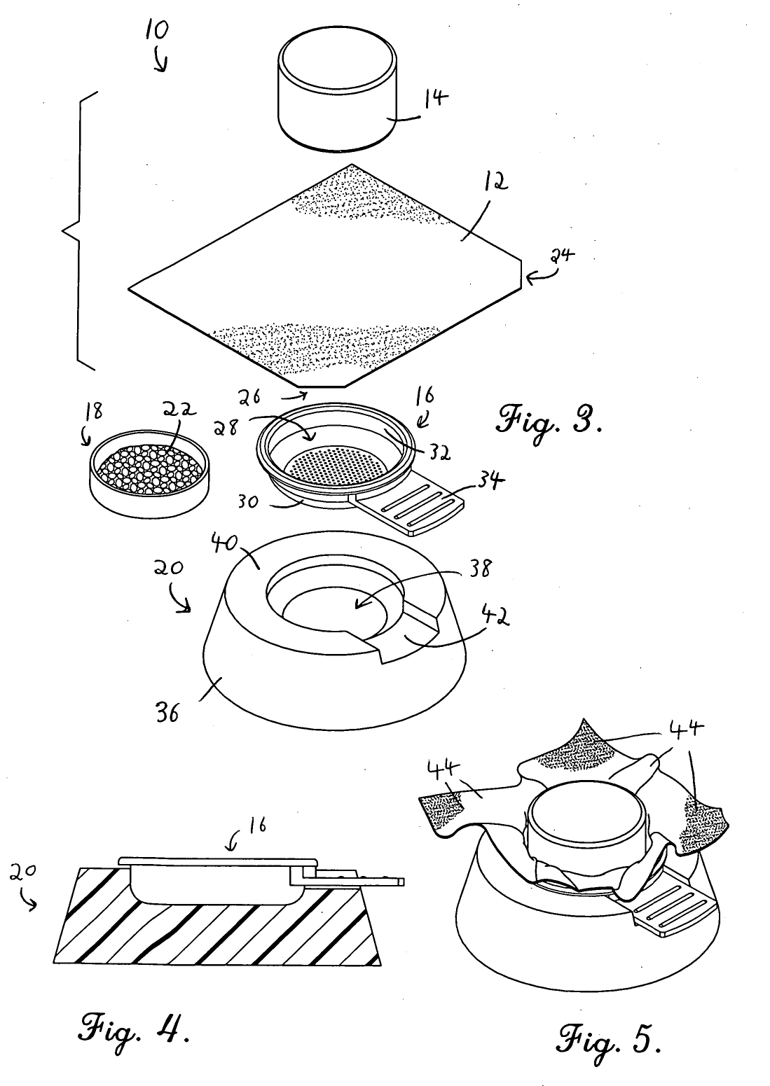

Referring initially to FIG. 3, an apparatus for assembling a coffee pod incorporating the principles of the present invention is depicted therein and designated generally by the reference numeral 10. Apparatus 10 includes at least a filter sheet 12, a plunger 14, and a receptacle 16. In the preferred embodiment, the apparatus 10 further includes a measuring container 18 and a base 20.

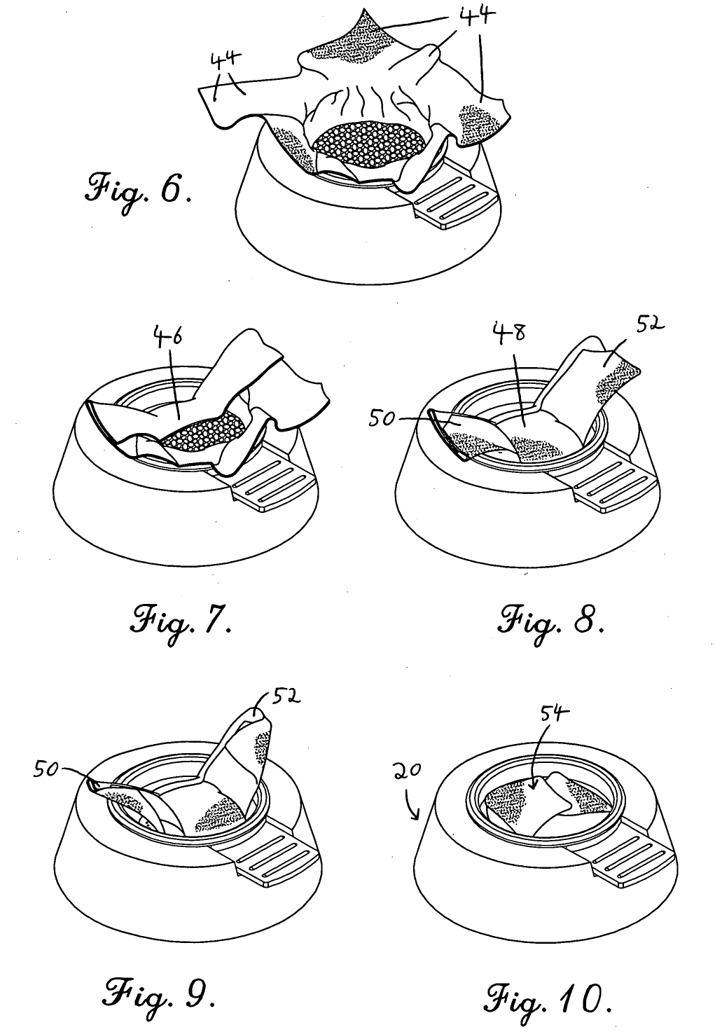

The filter sheet 12 generally is used to form a membrane for containing a beverage ingredient and allowing a fluid to pass therethrough. The illustrated filter sheet 12 is made of a permeable material adapted to contain coffee grounds, ground tea leaves, or similar fully or partially dissolvable beverage ingredients and thus is useful in making coffee, tea, or a similar beverage. While the apparatus will hereinafter be described for use with coffee grounds 22, the invention is not so limited and one of ordinary skill in the art will readily recognize that the apparatus may be used with a variety of ingredients to make various types of beverages. The filter sheet 12 is sufficiently large such that a portion thereof can conform to a cavity of the receptacle 16 (as explained below in greater detail) to receive the coffee grounds 22, while leaving a second, “loose” portion thereof large enough to be folded over and envelop the grounds 22 (see FIG. 6). The illustrated filter sheet 12 is substantially rectangular in shape and approximately four and one-half inches long and four inches wide.

The filter sheet 12 is made of a food-grade material that is sufficiently malleable to be folded to envelop the coffee grounds 22 without breaking or cracking, retains the coffee grounds 22 when thus folded, and is sufficiently permeable to allow a fluid, such as water, to pass therethrough. Because the filter sheet 12 will typically be used with a fluid that has been heated to a substantially high temperature, such as in the process of making coffee or tea, it is made of a material that will not disintegrate when exposed to the hot fluid for an extended length of time. The filter sheet 12 is preferably made of a cloth or paper based material that may be used once and discarded without substantial adverse cost effects. By way of example, the filter sheet 12 may be made of food contact wet crape eighteen-pound paper available from Rockland Industries of Sheboygan, Wis.

Alternatively, the filter sheet 12 may made of a more resilient material, such as rubber or an elastomer, that may be washed and reused repeatedly without significant degradation. A reusable filter sheet eliminates the need to purchase replacements sheets, but may need to be washed or otherwise cleaned periodically.

The filter sheet 12 includes two beveled corners 24,26, as illustrated in FIG. 3, which serve as indicators for indicating an orientation of the sheet 12. Such is particularly useful, for example, when the user is assembling the beverage ingredient packet wherein folds, wrinkles, and other deformations in the filter sheet 12 prevent the user from accurately ascertaining an orientation of the sheet (see FIG. 6). It will be appreciated that the illustrated beveled corners 24,26 are exemplary in nature and that bevels or other types of markings of various sizes and shapes may be used to indicate an orientation or position of the filter sheet 12.

The plunger 14 generally forces a portion of the filter sheet 12 to conform to a portion of a cavity 28 of the receptacle 16. The illustrated plunger 14 is substantially cylindrical in shape and presents a diameter of approximately one and three-quarters inches and a height of approximately one and one-quarter inches. A portion of an outer surface of the plunger 14 substantially conforms to the receptacle cavity 28 so that the plunger may be inserted into the receptacle 16 to force a portion of the filter sheet 12 to conform to the cavity 28. The plunger 14 is preferably made of a substantially rigid and lightweight material such as plastic or wood, and is preferably hollow to minimize the weight thereof.

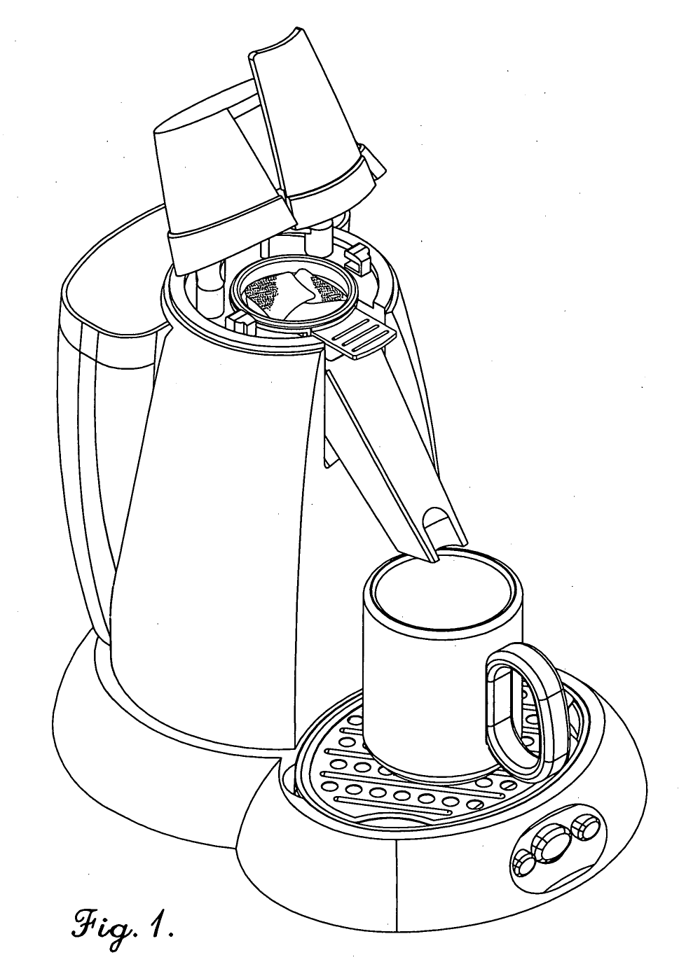

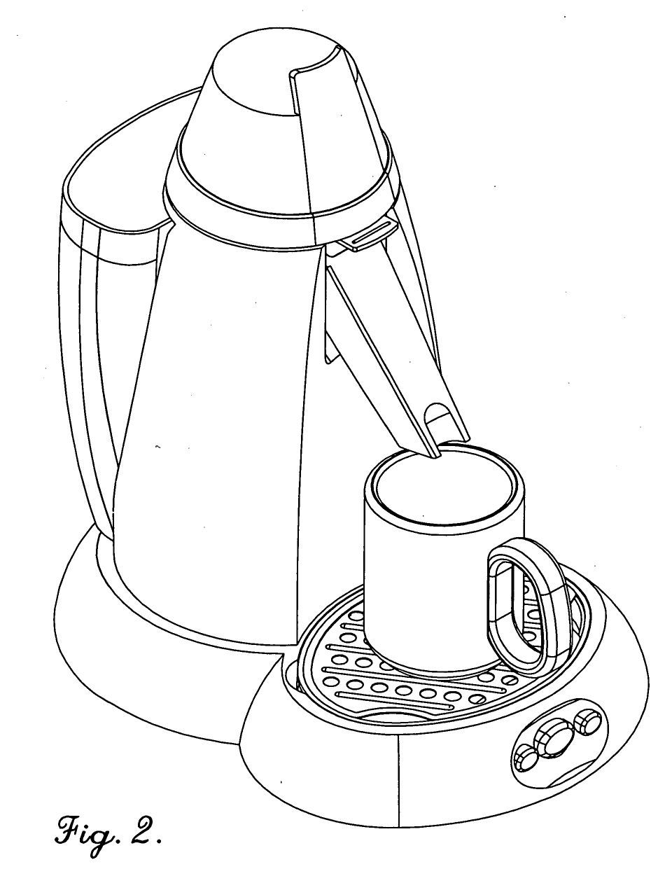

The receptacle 16 generally presents a cavity 28 for receiving a portion of the filter sheet 12 and for supporting the portion of the sheet 12 while the coffee grounds 22 are added thereto. The illustrated receptacle 16 includes a substantially circular, planar bottom wall 30 and an annular side wall 32. The bottom wall 30 and the side wall 32 define the cavity 28. The bottom wall 30 presents an array of close perforations for straining fluids that pass through the beverage ingredient packet. The receptacle 16 further includes a substantially straight handle 34 for enabling a user to quickly and easily grasp the receptacle 16 to place it in the coffee maker illustrated in FIGS. 1 and 2. Thus, the receptacle 16 serves not only to hold the filter sheet 12 while it is being filled with coffee grounds 22 and formed into a coffee pod, but further serves as a sieve for the coffee maker. Once the coffee pod is formed, the receptacle 16 is placed directly into the coffee maker without disturbing the coffee pod.

The plunger 14 and the receptacle 16 thus cooperate to form a mold, wherein the plunger 14 forms a thrust portion and the receptacle 16 forms a receptacle portion operable to shape the filter sheet 12 to form a receiving portion wherein the coffee grounds 22 are placed. While the plunger 14 and the receptacle 16 have been illustrated and described as being circular, it will be appreciated that the size and shape of the plunger 14 and receptacle 16 may be varied without departing from the spirit and scope of the invention, and that they may mold the filter sheet 12 to form a receiving portion of various shapes and sizes.

The measuring container 18 generally provides a means for measuring the coffee grounds 22 to be placed in the filter sheet 12. The illustrated measuring container 18 is in the form of a small measuring cup wherein a user measures the coffee grounds 22 by partially or completely filling the cup. The measuring cup may contain one or more indicators (not shown) for indicating to the user a preferred volume of coffee grounds 22. The coffee grounds 22 are poured from the cup into the receiving portion of the shaped filter sheet 12.

As is illustrated in FIG. 3, the plunger 14 and the receptacle 16 are adapted to mate such that the cavity 28 of the receptacle 16 fits over an end of the plunger 14. The measuring container 18 may likewise be adapted to mate with the plunger 14 and/or the receptacle 16 to minimize the amount of space required to store and transport the apparatus 10. Furthermore, the plunger may be adapted for measuring the coffee grounds 22 by including, for example, a cavity with one or more indicators for indicating a preferred volume of coffee grounds, obviating the need for a separate measuring container. With respect to this latter alternative, the plunger may be substantially similar to the measuring container 18 illustrated in FIG. 3, wherein a first portion of the plunger would be adapted to conform to the cavity 28 of the receptacle 16, and a second portion of the plunger would present a measuring cup for measuring the coffee grounds 22.

The base 20 generally receives and cradles the receptacle 16 while the coffee pod is being formed therein. The illustrated base 20 presents an annular side wall 36, a recess 38, a rim 40 defining a periphery of the recess 38, and a notch 42 defined by a cut-away portion of the rim extending from the side wall 36 to the recess 38. As illustrated in FIG. 4, the receptacle 16 fits neatly into the recess 38 of the base 20 wherein the handle 34 of the receptacle 16 is seated in the notch 42 of the base 20. The base 20 is particularly useful where the receptacle 16 may tend to move or slide during use, or wherein the handle 34 of the receptacle 16 extends downward to a point below the bottom wall 30 of the receptacle 16.

In use, the receptacle 16 is seated in the recess 38 of the base 20 as illustrated in FIG. 4. The filter sheet 12 is placed over the opening of the receptacle cavity 28, as illustrated in FIG. 3, and placed in contact with the receptacle 16 so that it is resting on a rim of the cavity 28. The plunger 14 is then thrust against the filter sheet 12 and into the receptacle cavity 28, thereby forcing a portion of the filter sheet 12 into the cavity 28, as illustrated in FIG. 5. Because the plunger 14 substantially conforms to the receptacle cavity 28, the portion of the filter sheet 12 forced into the cavity 28 substantially conforms to at least a portion of the cavity 28. The plunger 14 is then removed from the receptacle 16, leaving the filter sheet 12 in the receptacle cavity 28 and substantially conformed thereto. The portion of the filter sheet 12 substantially conforming to the receptacle cavity 28 thus defines a receiving portion of the sheet, into which the coffee grounds 22 are poured, as illustrated in FIG. 6, wherein a loose portion 44 of the sheet 12 surrounds the receiving portion.

With the coffee grounds 22 placed in the receiving portion of the filter sheet 12, the loose portion 44 of the sheet 12 is folded over the grounds 22 so that the sheet 12 envelops the coffee grounds 22, as illustrated in FIGS. 7-10. According to the preferred method of folding the filter sheet 12, the user first grips the non-beveled corners of the filter sheet and folds the corners toward the beveled corners 24,26 so that a first portion 46 of the filter sheet 12 is folded over the coffee grounds 22, as illustrated in FIG. 7. The user then grips the beveled corners 24,26 of the filter sheet 12 and folds the corners 24,26 over the first portion 46 so that a second portion 48 is folded over the first portion 46, as illustrated in FIG. 8.

Folding the first and second portions 46,48 over the coffee grounds 22 in this manner essentially wraps the filter sheet 12 around the grounds 22 so that the sheet 12 presents a first end 50 and a second end 52. A corner of the first end 50 is folded toward an opposing edge, and a corner of the second end 52 is likewise folded toward an opposing edge, as illustrated in FIG. 9. Folding the corners of the ends in this manner serves to “close” each end 50,52 and seal the filter sheet 12 to prevent the coffee grounds 22 from inadvertently falling therefrom. Finally, the first and second ends 50,52 are folded inward, as illustrated in FIG. 10, completing assembly of the coffee pod 54.

The receptacle 16 is then removed from the base 20 and placed into the coffee maker, as illustrated in FIG. 1, to make one or more servings of coffee. While a method of forming the coffee pod 54 has been explained wherein the coffee pod 54 is formed directly in the receptacle 16 while the receptacle is seated in the base 20, it will be appreciated that the method may be altered without departing from the scope of the present invention. The coffee pod 54 may be formed, for example, in a separate container (not illustrated), removed from the separate container, and placed into the receptacle 16. Furthermore, the receptacle 16 need not be placed in the base 20.

In an alternative implementation, the apparatus 10 may be used to assemble a packet of cleaning agent to clean a coffee maker or similar device. In the alternative implementation, the packet is assembled in substantially the same manner as the coffee pod described above, except that the filter sheet 12 is filled with a cleaning agent, such as sodium bicarbonate, soap or a detergent, instead of coffee grounds or other beverage ingredient. The cleaning agent is flushed through the coffee maker by, for example, causing the coffee maker to execute a brewing cycle or a special cleaning cycle.

Turning now to FIG. 11, an apparatus for assembling a coffee pod incorporating the principles of the present invention according to a second embodiment is depicted therein and designated generally by the reference numeral 100. Apparatus 100 includes at least a filter sheet 102, a plunger 104, and a receptacle 106. In the preferred embodiment, the apparatus 100 further includes a measuring container 108 and a base 110. The apparatus 100 is similar in form and function to the apparatus 10 described in detail above, therefore only the differences between the apparatus 10 and the apparatus 100 will be discussed here.

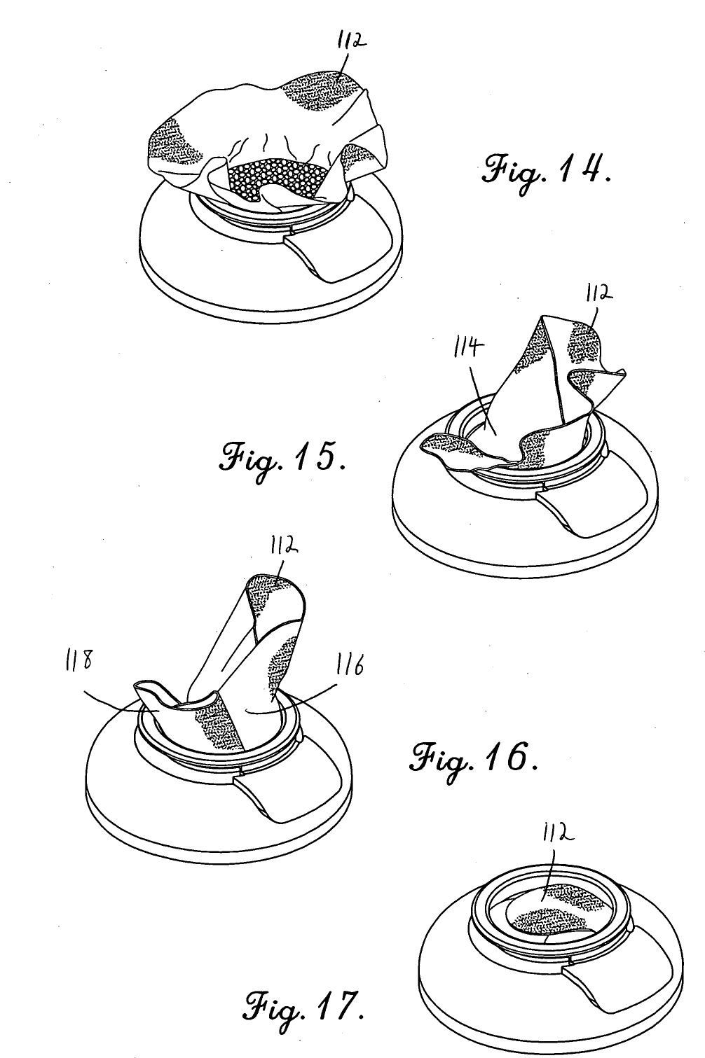

The filter sheet 102 performs substantially the same function as the filter sheet 12 discussed above, except that the filter sheet 102 is substantially circular with a flap 112 extending from a portion of a periphery of the sheet 102 for providing cover when the sheet 102 is folded over the ingredient. The filter sheet 102 is shaped substantially like a tear drop with a major axis of approximately five and one-half inches and a minor axis of approximately four and one-half inches. FIGS. 13-17 illustrate the filter sheet 102 being formed in the receptacle 106, filled with coffee grounds, and folded to form a coffee pod. The filter sheet 102 is formed into a coffee pod by folding a first portion 114 over the coffee pods, and then folding a second portion 116 over the first portion 114. A third portion 118 is then folded over the second portion 116, and the flap 112 is folded over the third portion 118 to complete the coffee pod. The flap 112 thus seals the coffee pod closed by laying on top of the other folded portions of the filter sheet 102. This is particularly advantageous where, for example, the various other portions 114,116,118 of the filter sheet 102 are not large enough to completely envelop or cover the coffee grounds.

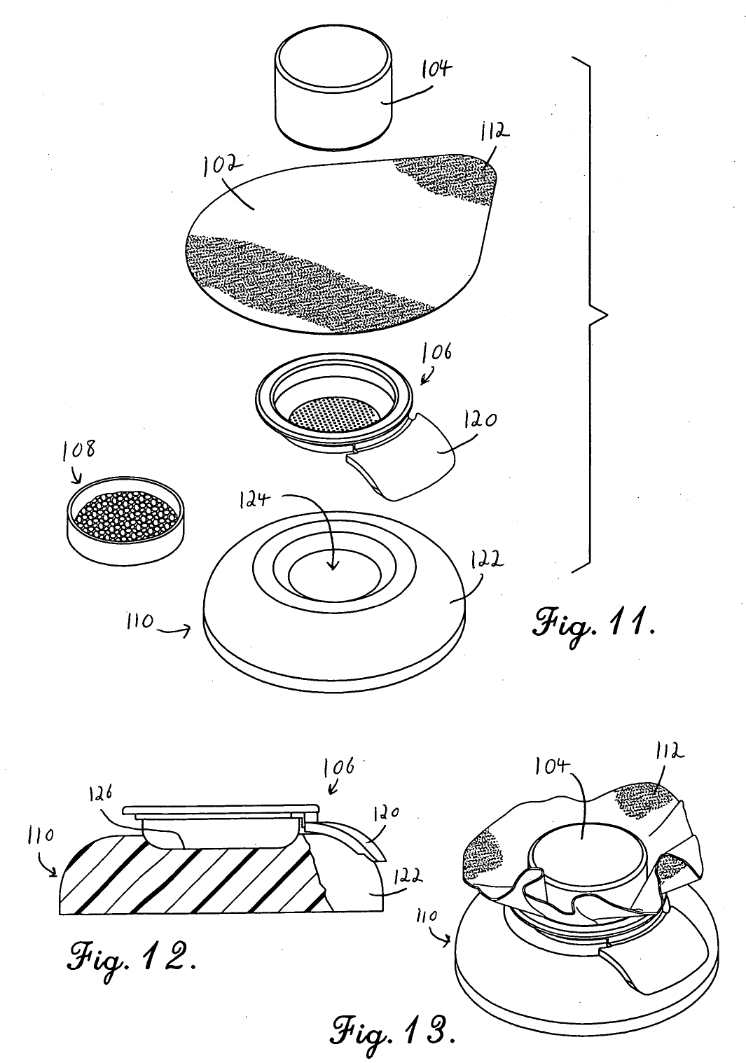

The apparatus 100 is further distinguished from the apparatus 10 in that the receptacle 106 presents a curved handle 120, and the base 110 does not include a notch between an outer wall 122 and a recess 124. The curved handle 120 of the receptacle 106 is common among receptacles sold with pod brewers, such as the pod brewer illustrated in FIGS. 1 and 2. The curved handle 120 presents a disadvantage, however, in that it extends below a bottom wall 126 of the receptacle 106, as illustrated in FIG. 12. If the receptacle 106 is placed on a flat surface, such as a table top or counter top, the receptacle 106 would not rest in a level position on the flat surface, but would be partially supported by the handle 120. Thus, it would be difficult to form a coffee pod in the receptacle 106 and the handle 120 may even be susceptible to damage if substantial downward pressure is applied to the receptacle 106, such as when a user is folding the filter sheet 102 to form the coffee pod.

The base 110 overcomes this disadvantage by properly supporting the receptacle 106 without placing undue strain on the handle 107. A recess of the base 110 receives and cradles the receptacle 106 as illustrated in FIG. 12, wherein the handle 107 is seated against an outer wall of the base 110. As clearly illustrated in FIG. 12, the handle 107 does not receive undue stress when a downward force is applied to the receptacle 106.

The inventor(s) hereby state(s) his/their intent to rely on the Doctrine of Equivalents to determine and assess the reasonably fair scope of his/their invention as pertains to any apparatus not materially departing from but outside the literal scope of the invention as set out in the following claims.

1. An apparatus for assembling a beverage ingredient packet, the apparatus comprising:
a membrane for containing the ingredient and for allowing a liquid to pass therethrough; and
a mold for shaping the membrane, the mold including—
a receptacle portion presenting a cavity for receiving a portion of the membrane, and
a thrust portion for forcing a portion of the membrane to substantially conform to a portion of the cavity.

2. The apparatus as set forth in claim 1, further comprising a measuring container for measuring the ingredient to be placed in the membrane.

3. The apparatus as set forth in claim 2, wherein the measuring container mates with a first end of the plunger and the receptacle mates with a second end of the plunger.

4. The apparatus as set forth in claim 1, wherein the thrust portion of the mold includes an ingredient measuring portion for measuring the beverage ingredient.

5. The apparatus as set forth in claim 1, wherein the membrane is a substantially rectangular filter sheet.

6. The apparatus as set forth in claim 1, wherein the membrane includes an indicator for assisting a user in orienting the membrane.

7. The apparatus as set forth in claim 6, wherein the indicator includes a beveled corner.

8. The apparatus as set forth in claim 1, wherein the membrane is substantially circular with a flap extending from a portion of a periphery of the membrane for providing cover when the membrane is folded over the ingredient.

9. The apparatus as set forth in claim 8, wherein the membrane is a filter sheet in the shape of a tear drop.

10. The apparatus as set forth in claim 1, wherein the membrane is made of an elastomer.

11. The apparatus as set forth in claim 1, wherein the receptacle cavity is substantially circular.

12. The apparatus as set forth in claim 1, further comprising a base for supporting the receptacle portion of the mold during use of the apparatus.

13. The apparatus as set forth in claim 12, wherein the base presents a recess for receiving and cradling the receptacle portion, and further presents an outer surface for supporting a handle of the receptacle portion.

14. The apparatus as set forth in claim 13, wherein the base further presents a notch in a rim of the recess for receiving the handle.

15. The apparatus as set forth in claim 1, wherein the receptacle portion is substantially perforated.

16. A method of assembling a beverage ingredient packet comprising the steps of:
(a) forcing a portion of a filter sheet into a cavity of a receptacle to cause a portion of the filter sheet to substantially conform to a portion of the cavity;
(b) placing the ingredient into the portion of the filter sheet that substantially conforms to the portion of the cavity; and
(c) folding the filter sheet so that the ingredient is enveloped by the sheet.

17. The method as set forth in claim 16, step (a) further comprising the step of:
(a1) using a plunger to force a portion of a filter sheet into a cavity of a receptacle to cause a portion of the filter sheet to substantially conform to a portion of the cavity.

18. The method as set forth in claim 16, step (c) further comprising the step of:
(c1) using an orientation indicator on the filter sheet to determine an orientation of the sheet.

19. The method as set forth in claim 16, step (c) further comprising the step of:
(c2) folding a first portion of the filter sheet to substantially cover the beverage ingredient, and folding a second portion of the filter sheet to substantially cover the first portion of the sheet.

20. The method as set forth in claim 19, step (c) further comprising the step of:
(c3) folding a corner of a first end of the folded sheet to seal the first end, and folding a corner of a second end of the folded sheet to seal the second end.

21. The method as set forth in claim 20, step (c) further comprising the step of:
(c4) folding the first end of the sheet over the portion of the sheet containing the ingredient, and folding the second end of the sheet over the first end of the sheet.

22. The method as set forth in claim 16, further comprising the step of:
(d) placing the receptacle into a recess of a base.

23. The method as set forth in claim 21, further comprising the step of:
(d1) placing the receptacle into a recess of the base so that a handle of the receptacle extends over a rim of the recess and is supported by the base.

24. A method of cleaning a beverage making device, the method comprising the steps of:
(a) forcing a portion of a membranous sheet into a cavity of a receptacle to cause a portion of the membranous sheet to substantially conform to a portion of the cavity;
(b) placing a cleaning agent into the portion of the membranous sheet that substantially conforms to the portion of the cavity;
(c) folding the membranous sheet so that the cleaning agent is enveloped by the sheet to form a cleaning packet;
(d) placing the packet in the beverage making device; and
(e) flushing the cleaning agent through the device by forcing a fluid through the cleaning packet.

25. The method as set forth in claim 24, wherein step (a) further comprises the step of:
(a1) using a plunger to force a portion of a membranous sheet into a cavity of a receptacle to cause a portion of the membranous sheet to substantially conform to a portion of the cavity.
